(19) United States
(12) Patent Application Publication
(10) Pub. No.: US 2014/0076168 A1
(43) Pub. Date: Mar. 20, 2014

(54) Hot Beverage Machine

(71) Applicant: Yu-Yuan Lin, Tainan (TW)

(72) Inventor: Yu-Yuan Lin, Tainan (TW)

(21) Appl. No.: 13/615,909

(22) Filed: Sep. 14, 2012

(51) Int. Cl. A47J 31/46

(52) U.S. Cl. 99/293

(57) ABSTRACT

The present invention provides an improved hot beverage machine, comprising a water reservoir provided on a main body for filling of water, a conduit extended from said water reservoir to guide a steam heated to a predetermined temperature to a water pipe and correspondingly to a location having a brewing material placed therein for brewing; wherein after a completely brewed hot beverage is in a tank for a predetermined time, an outlet of said tank is opened to allow brewed hot beverage to enter into a container underneath said outlet; characterized in that: an upper opening circumference of said tank can be mounted with a supporting stand and related components for the brewing material to be placed therein such that easy replacements of mechanical components of said hot beverage machine for brewing hot beverages can be achieved and the practical usages of the hot beverage machine can be enhanced.

### BACKGROUND OF THE INVENTION

1. Technical Field

The present invention is related to an improved hot beverage machine, in particular, to a hot beverage machine capable of producing various types of hot beverages provided for easy replacements of mechanical components used in actuation of the brewing of hot beverages, achieving the purpose of use of pre-brewing of drinks and to enhance the practical usage of the hot beverage machine.

2. Description of Related Art

Currently, there are numerous different types of hot beverage machines designed for brewing of various types of hot drinks, such as tea, coffee, and basically, it is deal to provide a hot beverage machine requiring only simple operations and manipulations to achieve the expected results of brewing of hot drinks with good tastes. For a known hot beverage machine, it typically provides one single function of use only; in other words, the hot beverage machine for brewing tea drinks includes a water reservoir on one side thereof for containing the water pouring therein and a water guiding conduit extended outward from one end of the water reservoir to guide the steam heated to a predetermined temperature to a top of the location of the tea or tea bag correspondingly in order to provide brewing of the tea or tea bag. The completely brewed tea drink would be contained in a tank of the hot beverage machine where the location of the tea or tea bag is, and it is provided for drinking after a predetermined time when the outlet of the tank is opened again to allow the drink to be poured into the container of the hot beverage machine. Such type of hot beverage machine cannot be used for brewing other type of drinks, such as coffee and requires users to purchase another suitable hot beverage machine for brewing coffee and related hot drinks, which causes extra purchases of hot beverage equipment at home to satisfy additional needs and also introduces problems to storage and increases the costs for such purchase.

### SUMMARY OF THE INVENTION

The present invention provides an improved hot beverage machine overcoming the drawbacks of known machines for brewing hot beverages such that easy replacements of mechanical components of said hot beverage machine for actuations of brewing hot beverages can be achieved in addition to the increased uses as well as applications of the hot beverage machine.

A first objective of the present invention is to provide an improved hot beverage machine for brewing tea, comprising a water reservoir provided on one side of a main body for filling of water, a section of conduit extended outward from one end of said water reservoir to guide a steam heated to a predetermined temperature to one end of a water pipe and correspondingly to a location having tea or tea bag placed therein on another end of said hot beverage machine for brewing said tea or tea bag; wherein after a completely brewed tea drink is contained within a tank for a predetermined time, an outlet of said tank is opened to allow said brewed tea drink to enter into a container placed underneath said outlet; characterized in that: an upper opening circumference of said tank of said hot beverage machine is mounted with a supporting stand having a central space thereof, and a bottom of said space of said supporting stand is formed with a through hole, and a receiving section extends downward from a circumference of said through hole to allow a filter cup to be tightly mounted thereon; and a small exit penetrates through said predetermined location of said tank and is attached to a blocker; and said blocker abuts said small exit on an upper end thereof and is mounted onto one side of a connecting member on a lower end thereof such that another side of said connecting member abuts a spring and said spring is directional restricted by a protrusion extended outward from said bottom of said tank; and said lower end of said blocker is controlled by a solenoid valve; said filter cup mounted on said upper opening of said tank and between said supporting stand for tea or tea bag to be placed therein; said steam heated to said predetermined temperature and guided to pass through said water pipe to enter into said filter cup for brewing of a tea drink; after a predetermined time and via said blocker on top of said solenoid valve, said small exit of said tank is opened for a brewed tea drink to enter into said container placed underneath.

A second objective of the present invention is to provide an improved hot beverage machine for brewing coffee, comprising a water reservoir provided on one side of a main body for filling of water, a section of conduit extended outward from one end of said water reservoir to guide a steam heated to a predetermined temperature to one end of a water pipe and correspondingly to a location having a coffee bag placed therein on another end of said hot beverage machine for brewing said coffee bag; wherein after a completely brewed coffee drink is contained within a tank for a predetermined time, an outlet of said tank is opened to allow said brewed coffee drink to enter into a container placed underneath said outlet; characterized in that: an upper opening circumference of said tank of said hot beverage machine is mounted with a supporting stand having a central space with a filter web at a bottom of said central space, and a receiving section extends downward from a lower end of said supporting stand to allow a guiding cup to be tightly mounted thereon, and one end of said guiding cup is formed of a cut-out facing downward; and said predetermined location of said tank is provided with a big exit extending upward therefrom, and said location of said big exit is correspondingly mounted on said cut-out of said guiding cup at said lower end of said supporting stand; a coffee bag being placed into said filter web on said bottom of said supporting stand mounted on said upper opening of said tank, and said steam heated to said predetermined temperature and guided to pass through said water pipe to enter into said supporting stand for brewing of said coffee bag such that a brewed coffee drink enters into said container placed underneath via said filter web and along said cut-out of said guiding cup corresponding to said big exit of said tank.

### BRIEF DESCRIPTION OF THE DRAWINGS

FIG. 1 is an exploded view of the hot beverage machine for brewing tea of the present invention;

FIG. 2 is an outer appearance view of the hot beverage machine for brewing tea of the present invention;

FIG. 3 is a front view of the hot beverage machine for brewing tea of the present invention;

FIG. 4 is a cross sectional view along 40-40 of FIG. 3;

FIG. 5 is an illustration showing the practice of brewing tea of the hot beverage machine of the present invention;

FIG. 6 is an illustration showing the completely brewed tea and tea drink entering into the container of the hot beverage machine of the present invention;

FIG. 7 is an exploded view of the hot beverage machine for brewing coffee of the present invention;

FIG. 8 is an outer appearance view of the hot beverage machine for brewing coffee of the present invention;

FIG. 9 is a lateral cross sectional view of the hot beverage machine for brewing coffee of the present invention; and

FIG. 10 is an illustration showing the practice of brewing coffee of the hot beverage machine of the present invention.

### DESCRIPTION OF EMBODIMENTS OF THE INVENTION

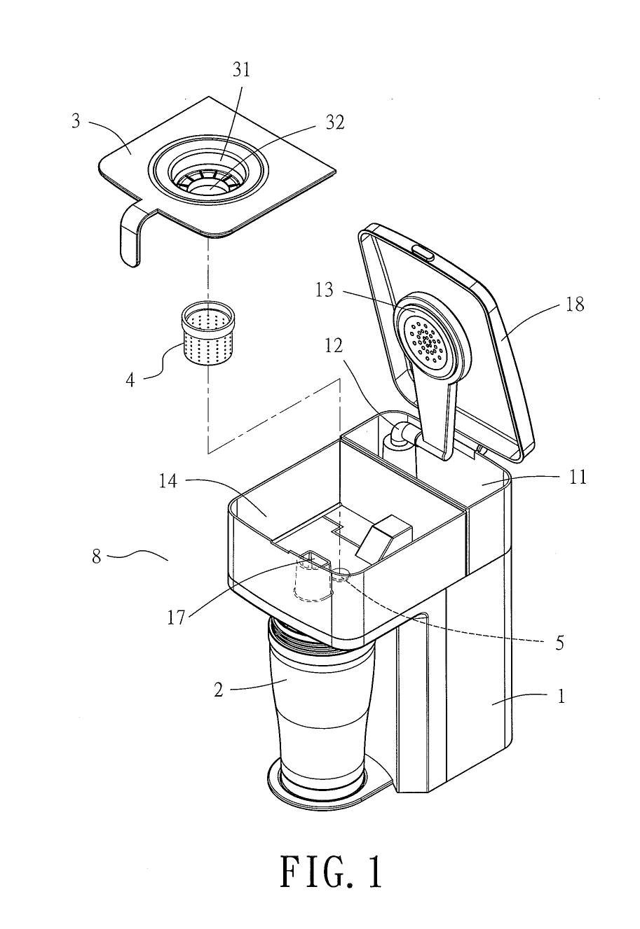

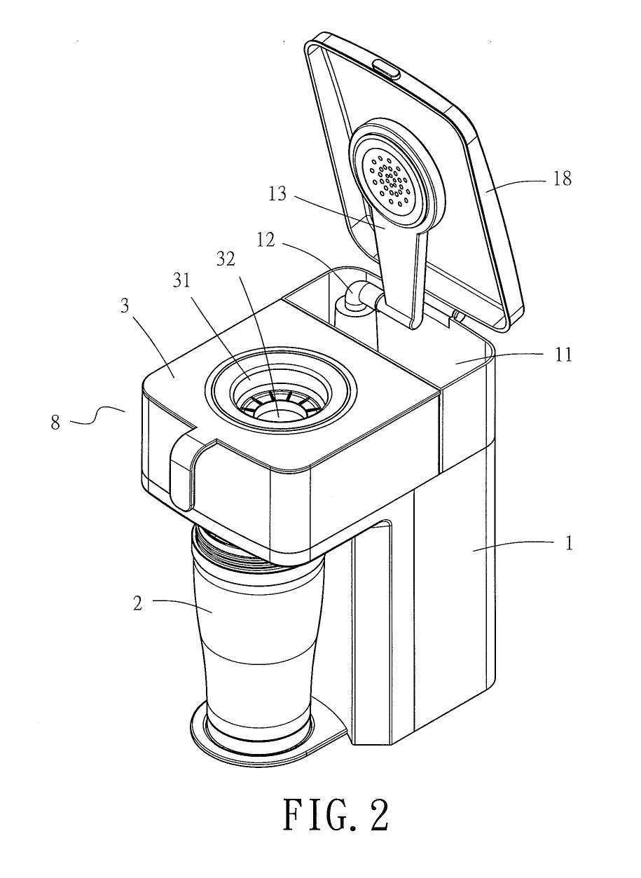

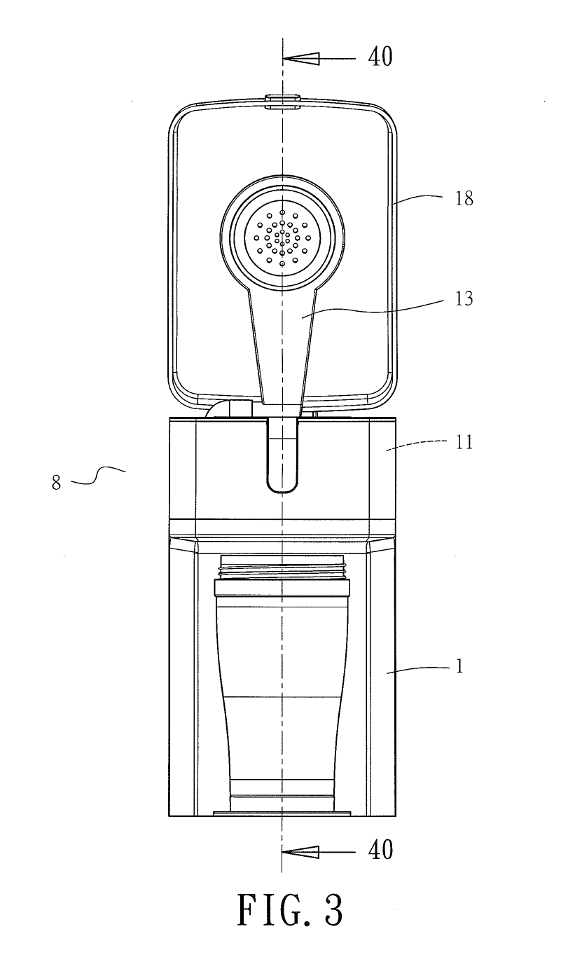

The improved hot beverage machine of the present invention, as shown in FIGS. 1, 3 and 7, is designed mainly for brewing various hot beverages or drinks, such as tea, tea bag or coffee, said hot beverage machine 8 comprises a water reservoir 11 provided on one side of a main body 1 for filling of water, a section of conduit 12 extended outward from one end of said water reservoir 11 to guide a steam heated to a predetermined temperature to one end of a water pipe 13 and correspondingly to a location having a brewing material placed therein on another end of said hot beverage machine 8 for brewing said brewing material; wherein after a completely brewed tea drink is contained within a tank 14 for a predetermined time, an outlet of said tank 14 is opened to allow said brewed tea drink to enter into a container 2 placed underneath said outlet; a cover 18 is pivotally attached to an upper side of said main body 1. The above is relate to a known configuration of the hot beverage machine 8 in which the present invention is characterized in that, as shown in FIGS. 1 and 2:

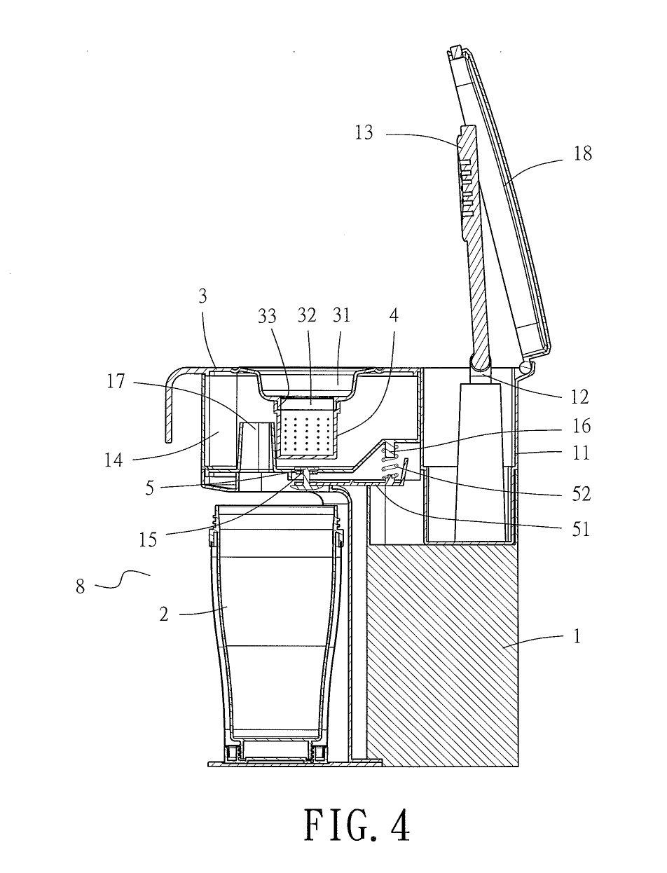

An upper opening circumference of said tank 14 of said hot beverage machine 8 is mounted with a supporting stand 3 having a central space 31 thereof, and a bottom of said space 31 of said supporting stand 3 is formed with a through hole 32, and a receiving section 33 extends downward from a circumference of said through hole 32 to allow a filter cup 4 to be tightly mounted thereon, as shown in FIG. 4. In addition, a small exit 15 penetrates through said predetermined location of said tank 14 and is attached to a blocker 5; and said blocker 5 abuts said small exit 15 on an upper end thereof and is mounted onto one side of a connecting member 51 on a lower end thereof such that another side of said connecting member 51 abuts a spring 52 and an upper end of said spring 52 is directional restricted by a protrusion 16 extended outward from said bottom of said tank 14. Furthermore, said lower end of said blocker 5 is controlled by a solenoid valve (the solenoid recited herein is not shown in the figure). Also, said predetermined location of said tank 14 is provided with a big exit 17 extending upward therefrom;

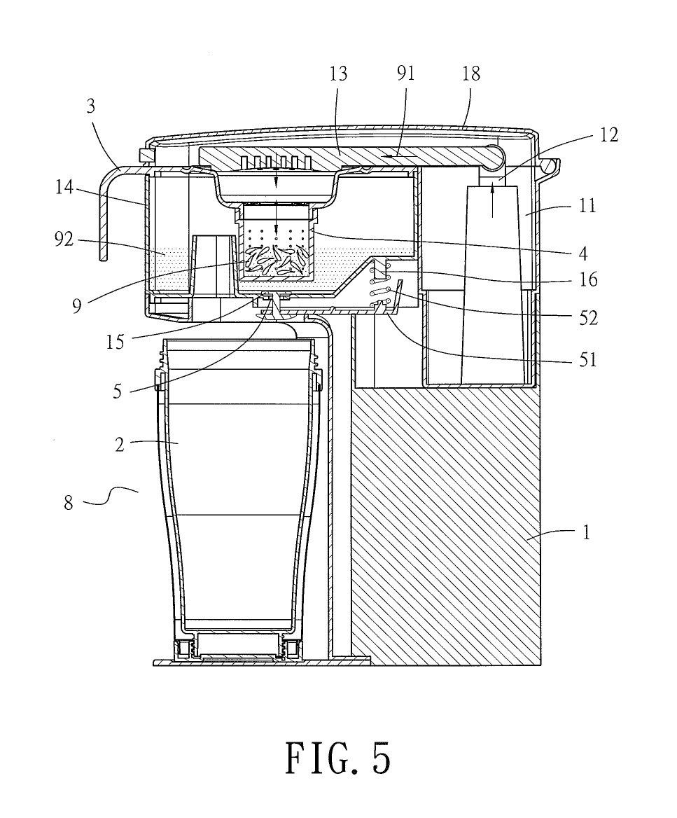

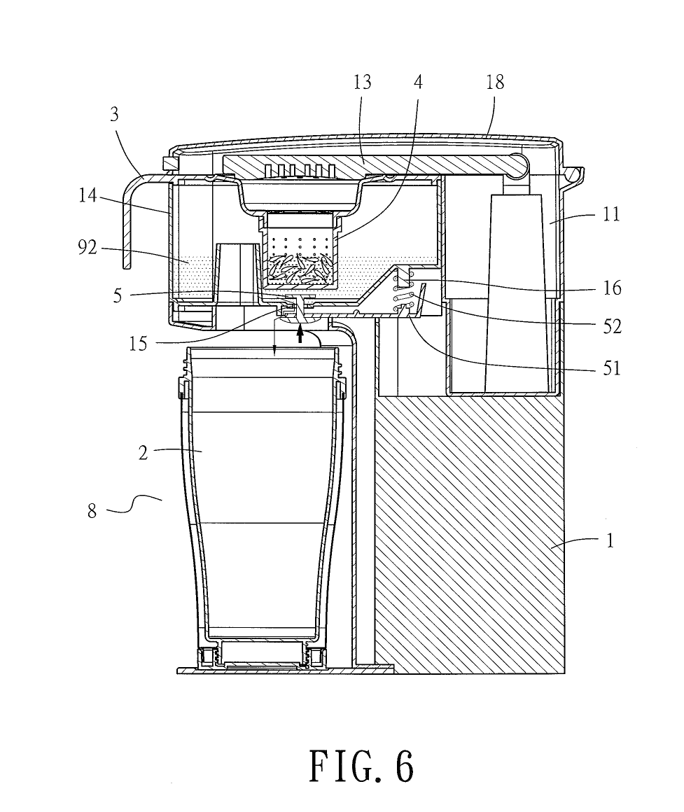

FIG. 5 shows the brewing of tea or tea bag of the hot beverage machine 8 of the present invention during its practical use. For a practical use, said filter cup 4 is mounted on said upper opening of said tank 14 and between said supporting stand 3 for the tea or tea bag 9 to be placed therein; and said steam 91 heated to said predetermined temperature is guided to pass through said water pipe 13 to enter into said filter cup 4 for brewing of a tea drink 92. After a predetermined time and via said blocker 5 on top of said solenoid valve, as shown in FIG. 6, said small exit 15 of said tank 14 is opened for said brewed tea drink 92 to enter into said container 2 placed underneath.

As the container 2 is filled with the tea drink to a desired level, the switch off state would switch the solenoid valve to an OFF state, causing the blocker 5 to block the small exit 15 again due to the connecting member 51 abutting the spring 52 against its spring recovery force and such that the pouring out of the tea drink 92 in the tank 14 is stopped.

Therefore, easy replacements of mechanical components of said hot beverage machine 8 for actuations of brewing hot beverages can be achieved and the practical usages of the hot beverage machine can be enhanced.

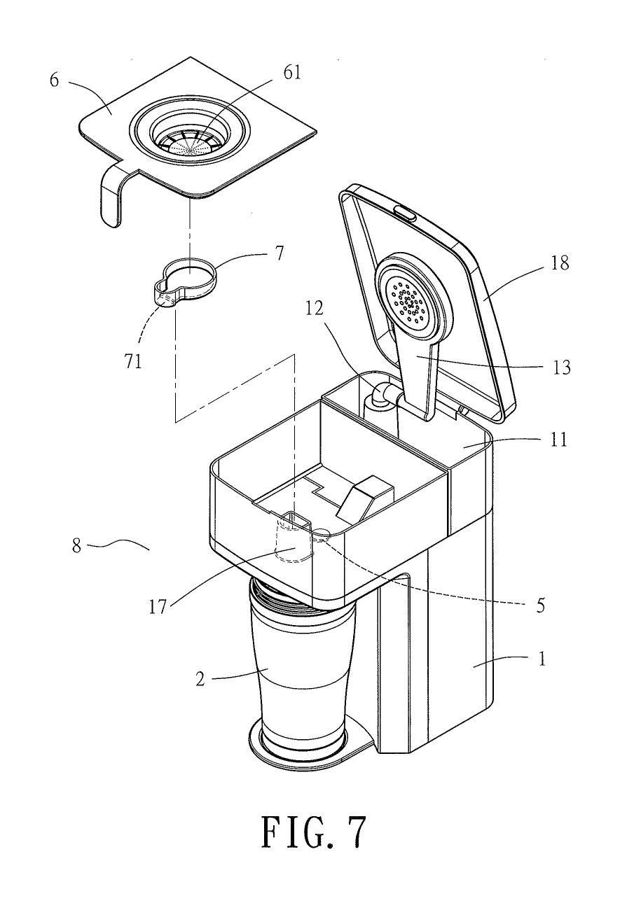

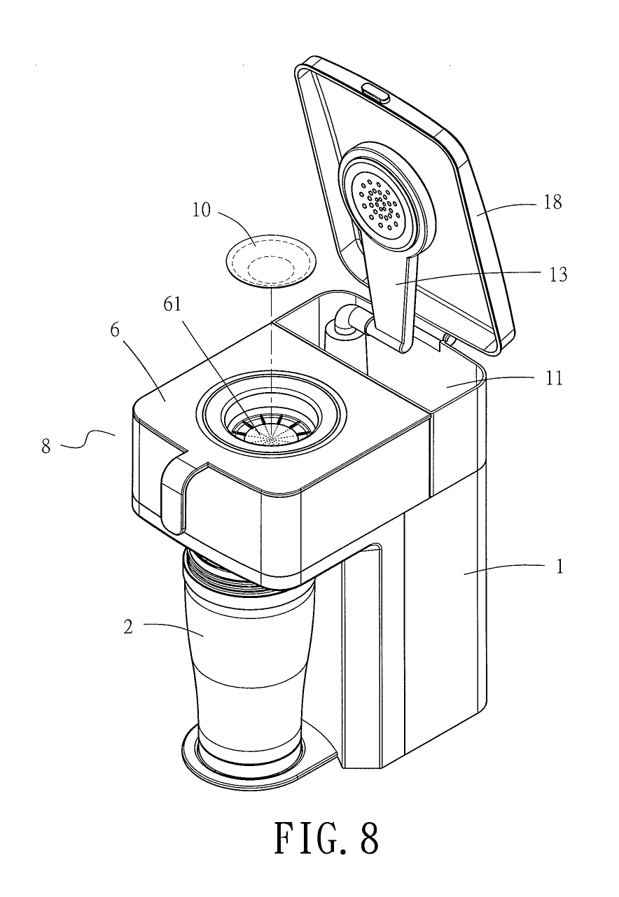

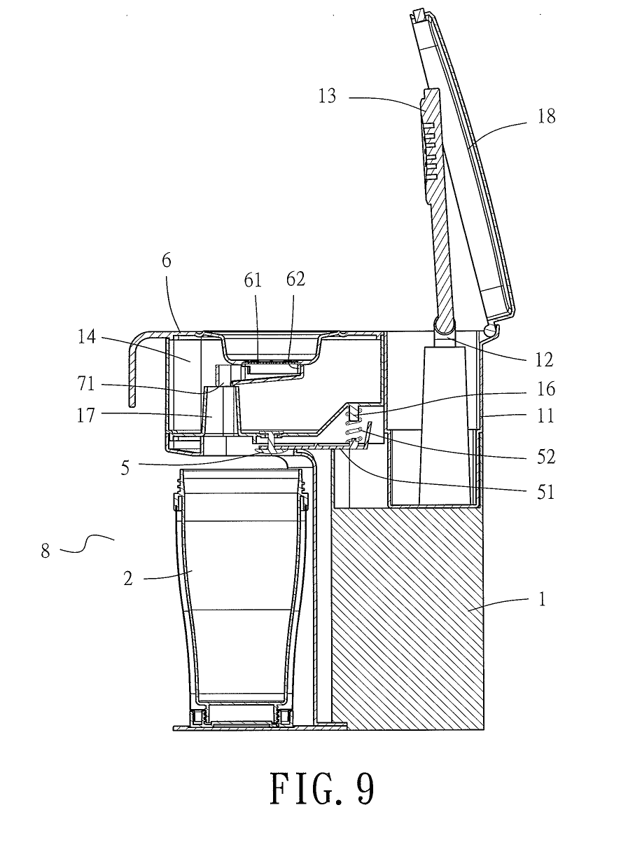

FIGS. 7 and 8 show an embodiment of the present invention of an improved hot beverage machine 8 for brewing coffee, which comprises an upper opening circumference of said tank 14 of said hot beverage machine 8 is mounted with a supporting stand 6 having a central space with a filter web 61 at a bottom of said central space, and a receiving section 62 extends downward from a lower end of said supporting stand 6, as shown in FIG. 9, to allow a guiding cup 7 to be tightly mounted thereon. In addition, one end of said guiding cup 7 is formed of a cut-out 71 facing downward. Also, said predetermined location of said tank 14 is provided with a big exit 17 extending upward therefrom, and said location of said big exit 17 is correspondingly mounted on said cut-out 71 of said guiding cup 7 at said lower end of said supporting stand 6.

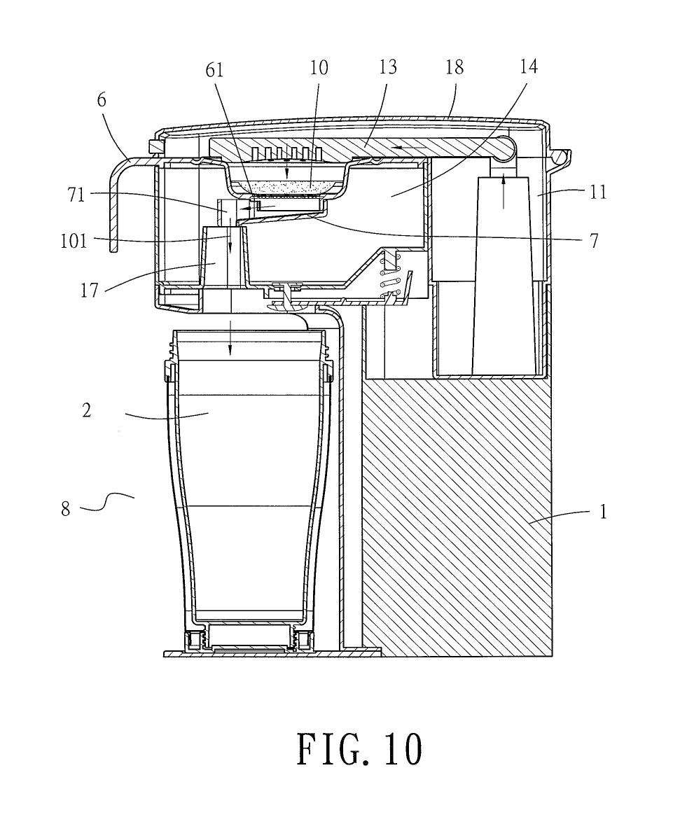

As shown in FIG. 10, a coffee bag 10 is placed into said filter web 61 on said bottom of said supporting stand 6 mounted on said upper opening of said tank 14, and said steam 91 heated to said predetermined temperature is guided to pass through said water pipe 13 to enter into said supporting stand 6 for brewing of said coffee bag 10 such that a brewed coffee drink 101 enters into said container 2 underneath via said filter web 61 and along said cut-out 71 of said guiding cup 7 corresponding to said big exit 17 of said tank 14 and such that easy replacement of mechanical components of said hot beverage machine 8 for actuations of brewing hot beverages is achieved.

What is claimed is:

1. An improved hot beverage machine, comprising a water reservoir provided on one side of a main body for filling of water, a section of conduit extended outward from one end of said water reservoir to guide a steam heated to a predetermined temperature to one end of a water pipe and correspondingly to a location having a brewing material placed therein on another end of said hot beverage machine for brewing said brewing material; wherein after a completely brewed hot beverage is contained within a tank for a predetermined time, an outlet of said tank is opened to allow said brewed hot beverage to enter into a container placed underneath said outlet;
characterized in that: an upper opening circumference of said tank of said hot beverage machine is mounted with a supporting stand having a central space thereof, and a bottom of said space of said supporting stand is formed with a through hole, and a receiving section extends downward from a circumference of said through hole to allow a filter cup to be tightly mounted thereon; and a small exit penetrates through said predetermined location of said tank and is attached to a blocker; and said blocker abuts said small exit on an upper end thereof and is mounted onto one side of a connecting member on a lower end thereof such that another side of said connecting member abuts a spring and an upper end of said spring is directional restricted by a protrusion extended outward from said bottom of said tank; and said lower end of said blocker is controlled by a solenoid valve; and said predetermined location of said tank is provided with a big exit extending upward therefrom;
said filter cup mounted on said upper opening of said tank and between said supporting stand for tea or tea bag to be placed therein; said steam heated to said predetermined temperature and guided to pass through said water pipe to enter into said filter cup for brewing of a tea drink; after a predetermined time and via said blocker on top of said solenoid valve, said small exit of said tank is opened for said brewed tea drink to enter into said container placed underneath and such that easy replacement of mechanical components of said hot beverage machine for actuations of brewing hot beverages is achieved.

2. An improved hot beverage machine, comprising a water reservoir provided on one side of a main body for filling of water, a section of conduit extended outward from one end of said water reservoir to guide a steam heated to a predetermined temperature to one end of a water pipe and correspondingly to a location having a brewing material placed therein on another end of said hot beverage machine for brewing said brewing material; wherein after a completely brewed hot beverage is contained within a tank for a predetermined time, an outlet of said tank is opened to allow said brewed hot beverage to enter into a container placed underneath said outlet;
characterized in that: an upper opening circumference of said tank of said hot beverage machine is mounted with a supporting stand having a central space with a filter web at a bottom of said central space, and a receiving section extends downward from a lower end of said supporting stand to allow a guiding cup to be tightly mounted thereon, and one end of said guiding cup is formed of a cut-out facing downward; and said predetermined location of said tank is provided with a big exit extending upward therefrom, and said location of said big exit is correspondingly mounted on said cut-out of said guiding cup at said lower end of said supporting stand; and a small exit penetrates through said predetermined location of said tank and is attached to a blocker, an upper end of said blocker is able to block said small exit and a lower end of said blocker is mounted on one side of a connecting member such that another side of said connecting member abuts a spring and an upper end of said spring is directional restricted by a protrusion extended outward from said bottom of said tank;
and said lower end of said blocker is controlled by a solenoid valve;
a coffee bag being placed into said filter web on said bottom of said supporting stand mounted on said upper opening of said tank, and said steam heated to said predetermined temperature and guided to pass through said water pipe to enter into said supporting stand for brewing of said coffee bag such that a brewed coffee drink enters into said container underneath via said filter web and along said cut-out of said guiding cup corresponding to said big exit of said tank and such that easy replacement of mechanical components of said hot beverage machine for actuations of brewing hot beverages is achieved.
